(19) United States
(12) Patent Application Publication
(10) Pub. No.: US 2004/0068459 A1
(43) Pub. Date: Apr. 8, 2004

(54) Method and system for the creation of a dynamic offering

(75) Inventors: Nicolas Goulet, Madrid (ES); Alexander Avery, Madrid (ES); Frank E. Wade, Madrid (ES); Jose Bolorinos, Madrid (ES)

Correspondence Address: OSTROLENK FABER GERB & SOFFEN, 1180 AVENUE OF THE AMERICAS, NEW YORK, NY, 100368403

(73) Assignee: capXnow, S. L.

(21) Appl. No.: 09/781,065

(22) Filed: Feb. 9, 2001

(51) Int. Cl. G06F 17/60

(52) U.S. Cl. 705/37

(57) ABSTRACT

A method for creating a dynamic offering for perishable goods and services in an electronic trading system. A producer enters details about units of inventory. A purchaser enters details of purchaser profile and search criteria. The producer may analyze historical data concerning ways of offering to select a manner of offering and the producer sets the offering rules and activates and deactivates them. The offering is put into a core engine database. A dynamic offering for the perishable goods and services is made based on the intermediate offers contained in a core engine database and on the purchaser profile and search criteria, so that the dynamic offering is tailored to each purchaser and optimizes both the producer and purchaser situations. Also a system for creating the dynamic offering including elements performing the method is disclosed.

The present invention relates to a method and system for the creation of a dynamic offering for perishable goods and services through an electronic trading system. Said method and system combine dynamic pricing with other offering elements in which the purchaser finds value, to create a customized package that the producer can route to a given set of channels according to some predefined choices.

### BACKGROUND OF THE INVENTION

Perishable goods and services represent a large proportion of the goods and services traded on economic terms. Examples of such goods and services are passenger transportation and accommodation services (airlines, rail, cruises, advertising services, entertainment, etc.)

Producers of such perishable goods and services (perishable assets) try to sell, or place, all units of inventory at the highest possible price before they expire. Perishable goods and services are defined as goods or services whose value diminishes with time, eventually becoming worthless on the expiration date. At any given point in time, the value of a perishable asset can be measured by multiplying the intrinsic value to the purchaser by the risk factor of no placement. As the risk factor of no placement increases with time, the value of the asset decreases until it can no longer be placed, which is the point of expiration. Producers extract value from perishable goods and services by placing them in advance of their expiration. Ideally, producers attempt to place every unit of inventory prior to expiration. For instance, an airline will try to place every seat on a given flight. Any unsold seats expire as soon as the flight departs. In this case, the producer is the airline, the unit of inventory is the seat, and the expiration is the departure date.

Perishable goods and services can be grouped into two main categories depending on the status of their commercialization: unsold (excess) inventory (where supply exceeds demand) and sold inventory (where demand equals or exceeds supply). Sold inventory can be further categorized into standard inventory (supply approximately equals demand) and oversold inventory (demand significantly exceeds supply).

Excess inventory is of particular concern to producers. Producers attempt to sell every unit of inventory before the value of that inventory expires. In most cases, only part of the total available inventory is sold, with the remainder becoming worthless on the expiration date. The costs associated with excess inventory are borne by purchasers of sold inventory, as fixed costs are spread over fewer units. Therefore, excess inventory has the effect of increasing average prices to purchasers and/or decreasing overall revenues to producers.

Oversold inventory is also of concern to the producers. At a given price, demand for a product or service can often exceed supply. When this happens in traditional fixed-price markets, the actual market value of the product or service is higher than the selling price. Many consumers would willingly pay a premium for the inventory, given the opportunity to do so. Producers do not realize this premium unless the market price increases dynamically with market demand. Furthermore, once a given set of inventory becomes oversold, additional offers for that inventory become more valuable. Hence the producer will prefer to offer that inventory to customers that are more valuable in the long term.

Producers face an additional dilemma that is of particular concern: Traditionally it has been difficult to quantify and act upon the difference between making an offer to a customer or purchaser based on his immediate cash contribution and making an offer to a customer based on his long term potential for cash contribution. These two aspects are called short-term cash yield and total yield. In order to be accurate total yield must incorporate a measure of the potential loyalty of the customer to the inventory. In cases where the customer's loyalty can be increased and/or measured, it may be more profitable in the long run for the producer to choose to give the unit of inventory for free to a valuable customer (e.g.; a frequent flyer) rather than get a immediate cash payment from a one time customer.

### SUMMARY OF THE INVENTION

The present invention advantageously fills the aforementioned deficiency in the prior art by assisting producers in the placement of perishable goods and services via the Internet and other communication networks, while at the same time maximizing total yield derived from such placement and strengthening relationships between purchasers, producers and channels.

One object of the present invention is to provide producers and channels with a means of presenting the offering in real time, either via a dynamic pricing system, a market-based pricing system or fixed pricing. The first mechanism automatically generates an online price of an asset, based on a predefined algorithm. One of those algorithms is the so called Dutch Auction, where a given asset is offered at a price that constantly drops in metered increments until either all units have been sold or until the auction ceases. Other algorithms will use different shapes of descending price curves or introduce variables other than time that govern price movements, such as number of viewers, number of seats left, time to expiration and time from last purchase. The present invention enables producers and channels to use these pricing mechanisms to offer units of inventory on their websites and within chosen channels. In the case of a market-based pricing system, the price of the asset changes dynamically as a function of changes in supply and demand, following a “bid-ask model”. The most widely known example of this model in use to date is in equity markets, where prices change dynamically based on supply and demand for a particular equity. In this model, purchasers place a bid to buy an asset at a given price, or place an order to buy the asset at the market price in effect at the time. The asset changes hands when an ask and a bid match. The present invention enables producers and channels to use the market-based pricing methodology to offer units of inventory on channel websites.

Another object of the present invention is to provide the producer with the ability to choose where an offering is presented. In the traditional distribution models and in more recent Internet intermediary development, the producer generally has to choose a specific channel that is using any given pricing mechanism. Thus the producer is forced to place the offering according to the pricing mechanism used by the channel. The present invention enables the producer to decouple the choice of the pricing mechanism from the choice of the channel; thus providing the producer with an additional degree of flexibility and control in his distribution and marketing strategy. The invention also provides the ability to select specific purchaser segments independently from the channel being used. Thus the producer can effectively route an offering of oversold inventory to the more valuable purchasers.

Another object of the present invention is to provide the producer with the ability to choose the negotiation rules that control the manner in which the offering is presented to the purchaser. Again in the traditional models, the choice of a given channel was generally associated with a given set of rules that were specific to the channels (e.g.; the name of the producer was not visible to the end purchaser, or the rules governing the flexibility of the goods and services were specific to the channel). The present invention enables the producer to decouple those rules from the choice of a pricing mechanism and the choice of a given channel.

Another object of the present invention is to provide producers the ability to offer non-price components of value to the purchaser based on specific criteria, at a given point in time. Non-price components are any elements of an offering aside from price. Non-price components can be broadly grouped into two categories: Terms & Conditions and Use of Certain Assets. Terms & Conditions may include intangibles such as different configurations of the product (times, classes, etc.), payment terms, coupons, upgrades, mileage bonuses, special customer service arrangements, flexible change terms, access to privileged information, etc. Use of Certain Assets grants the purchaser access to certain assets held by the producer, the channel, or some other party, and may include some type of insurance, limousine service, departure lounge access, access to office space & facilities, gifts of tangible goods, etc.

Another object of the invention is to combine the above mentioned choices (pricing mechanism and algorithm, purchaser segment, choice of channels and choice of negotiation rules) into a single, effective decision making mechanism through which the producer has the ability to change each one of those four components in real time, independently and relative to any inventory grouping. The invention can manipulate inventory groupings that have any combination of parameters possible, from complex combinations based on search criteria (e.g.,; dates, location, timing, etc..) down to the level of a single unit of inventory (e.g.; one seat on an given flight). The system provides the producer with interfaces that work as a “control panel” for the inventory he chooses to place through the system. This control panel effectively manages the automatic connectivity of the system with the producer's legacy systems for yield management, inventory management and revenue management. The system is also designed to ensure that all the business procedures related to the fulfillment of the offering (connection to reservation systems, payment systems and other elements) are included.

Another object of the invention is to provide an affiliation mechanism for channels that enables a large combination of on-line, fixed and alternative channels to be integrated into the system. This object will provide the producers with the greatest set of alternatives with respect of the choice of channels.

Another object of the invention is to provide the producer with modeling and analysis tools to assist in the compilation of offers. Using data collected from previous transactions fulfilled by the system, the invention provides an analysis and modeling interface to the producer to evaluate potential outcomes of possible offer combinations.

The invention refers to a method for the creation of a dynamic offering for perishable goods and services in an electronic trading system, being said system accessible by at least, one producer, one purchaser and one channel.

Producers include any party that holds perishable goods and services such as airlines (airline seats), tour operators (travel tickets), performance companies (theatre tickets) and cargo operators (cargo space). Channels are intermediaries to whom access has been provided that will route the offers to purchasers and provide fulfillment support. Channels of perishable goods and services include travel agents, travel-related websites, ticket box offices, and the producers themselves. Distribution can be carried out using various means of communication, such as telephone, fax, Internet, and face-to-face sales. Purchasers include any party who wishes to access the dynamic offer(s) directly.

This method comprises the steps of:

the producer entering details about individual units of inventory, into an Inventory database via a producer interface

the purchaser interacting with the channel via a channel interface and entering details of purchaser profile and search criteria,

the producer electing to analyze historical data concerning the relative effectiveness of various combinations of offering elements, and conducting simulations that attempt to predict the efficacy of a particular offering, based on said historical data, and using said simulations, to predict the performance of a particular combination of offering elements to use in creating a new offering

the producer selecting and/or defining elements about offering rules, into an Offering Rules database via said producer interface,

the producer activating/deactivating said offering rules

the producer creating intermediate offers assigning the offering rules contained in the Offering Rules database to the inventory contained in the Inventory database, which intermediate offers are stored in a Core Engine database,

a core engine constructing a dynamic offering for said perishable good or service based on the intermediate offer contained in the Core Engine database and on the purchaser profile and search criteria,

such that the dynamic offering constructed is tailored uniquely to each purchaser, and optimizes both the producer and the purchaser situations, creating and adding value for both the producer and the purchaser and also to the channel.

The entry of inventory comprises the steps of:

the producer generating inventory,

the producer identifying units of inventory to be made available and associating each unit to an inventory code, which inventory codes are organized and stored in an Inventory Codes Database,

generating a directory of all inventory that could possibly be offered,

the producer entering inventory details into an Inventory Details database,

the inventory codes are associated with said details and stored in the Inventory database.

And, the entry of offering rules comprises the steps of:

the producer entering a predefined set of inventory group codes, that act as filters against the Inventory database to select only the units of inventory that meet certain criteria,

the producer entering a predefined set of offering rules, which are organized and stored in the Offering Rules database, said offering rules including

i. pricing rules,

ii. purchaser segment rules,

iii. channel filtering rules,

iv. negotiation rules

v. offering administration rules

said offering rules being assigned to individual units of inventory based on predefined offering parameters.

Said pricing rules determine both a pricing mechanism and a pricing algorithm to be used during the offering. Said purchaser segment rules designate characteristics of the purchaser segment to which the offering will be targeted. Said channel filtering rules determine through which channels the offering will be made available. Said negotiation rules designate certain non-price elements to be included in the offering, including Terms and Conditions and Use of Certain Assets. Said offering administration rules determine when an offering will be made available to the channels, for how long the offering will last and how often it will be repeated.

The method of the invention may include the steps of notifying a third party via the corresponding interfaces of a potential transaction, and facilitating the participation of said third party in the offering and closing of the transaction.

The invention also relates to a system for the creation of said dynamic offering; said system includes at least, one producer, one purchaser and one channel, and also electronic or physical connections between said parties.

The system further includes a core engine, which constructs a dynamic offering for said perishable good or service based on an intermediate offer contained in a Core Engine database and on a purchaser profile and search criteria entered by said purchaser, such that the dynamic offering constructed is tailored uniquely to each purchaser, and optimizes both the producer and the purchaser situations, creating and adding value for both the producer and the purchaser and also to the channel.

The system includes an Inventory database which contains inventory data entered by the producer and an Offering Rules database, which contains offering rules entered by the producer.

Preferably, the offering rules include inventory group codes, pricing codes, purchaser segment rules, channel filtering rules, negotiation rules and offering administration rules.

The system may preferably include third parties with corresponding interfaces.

The system may preferably include access for third parties with the corresponding interfaces; said third parties include any party who wishes to offer elements that are available at the time of construction of the offer. Said third parties may wish to access the Core Engine directly through a specific Automatic Programmable Interface.

Via the corresponding interfaces the third party is notified of a potential transaction, enabling participation in the offering and the closing of the transaction. Third parties may also include enabling systems such as payment facilitators, reservations systems, logistics companies and credit card companies.

For purposes of clarification, a glossary of the terms used throughout the disclosure of the invention is provided hereby:

| | |
|---|---|
| Associated | Inventory that can be combined with a specific unit of |
| Inventory | inventory, such as return flights. |
| Cash Yield | Net cash proceeds to a Producer of a commercial |
| | exchange with a Purchaser. |
| Channel | Distribution means that acts as an intermediary between the |
| | Purchase and the capXnow database. |
| Channel | Rules defined by the Producer that govern specific |
| Filtering | Channels to which the Offering will be made available. |
| Rules | |
| Core Engine | Information-processing center of the invention that develops |
| | and delivers Dynamic Offerings based on Offering Rules, |
| | available Inventory, Purchaser Search Criteria and |
| | Purchaser Profile information. |
| Core Engine | Database that stores Offerings that have been created by |
| Database | Producers for use at a future time. |
| Dynamic | A unique combination of Offering Elements delivered to a |
| Offering | Purchaser through a Channel Interface, said combination |
| | being based on specific Offering Rules applied to |
| | Inventory Group Codes, and being further filtered by |
| | Purchaser Search Criteria and Purchaser Profile |
| | information. |
| Dynamic | Method of pricing a good or service during an Offering, |
| Pricing | whereby the price changes with time. |
| Enabling | Third Parties who participate in an Offering by providing |
| Systems | services that facilitate or optimize the transaction, such as |
| | credit card companies, reservations systems and logistics |
| | companies. |
| Excess | Inventory whose supply exceeds demand. |
| Inventory | |
| Expiration | The specific point in time when a Perishable Good or |
| | Service becomes worthless, such as departure of an |
| | aircraft. |
| Interface | A two-way electronic presentation of information between |
| | a user (such as a Purchaser, Channel or Producer) and a |
| | database. |
| Inventory | Units of capacity generated by the Producer. |
| Inventory | Codes that refer to a specific type of Inventory, such as |
| Codes | flight numbers. |
| Inventory | Data stored in the Inventory Database that is specific to |
| Data | a unit of Inventory, such as flight number and type of |
| | aircraft. |
| Inventory | Database of Inventory Codes plus Inventory Details. |
| Database | |
| Inventory | Catalog of Static Inventory Data that is stored in the |
| Details | Inventory Details database and added to the Inventory |
| | Codes to provide the Purchaser with complete details on |
| | a unit of inventory. |
| Inventory | Codes that designate a specific aggregation of |
| Group | Inventory, based on certain rules that are defined by the |
| Codes | Producer. |
| Inventory | A specific aggregation of inventory, based on certain rules |
| Grouping | that are defined by the Producer. |
| Modeling | Mathematical simulation of probable future outcomes based |
| | on assumptions and historical data. |
| Negotiation | A set of Producer-defined rules that govern the integration |
| Rules | of non-price elements into the offering, such as Terms & |
| | Conditions and Use of Certain Assets. |
| Non-Price | Any elements of an Offering aside from price, such as |
| Components | Terms & Conditions and Use of Certain Assets. |
| Offering | A combination of Offer Elements that is stored in the Core |
| | Engine Database, said combination being defined by the |
| | Producer in anticipation of activation and acceptance by the |
| | Purchaser via a Search Query. |
| Offering | A specific set of rules, defined by the Producer, that will |
| Admini- | govern when the offering is held, how long it will last, and |
| stration | how often it will be repeated. |
| Rules | |
| Offering | Individual components that govern the parameters by which |
| Elements | an offering will be made, such as Pricing Mechanism, |
| | Purchaser Profile, Negotiation Rules, Channel Filtering |
| | Rules, and specific Inventory to be made available. |
| Offering | A specific set of rules, defined by the Producer, that will |
| Rules | govern what Inventory will be offered to whom through |
| | which Channel at what time and at what price, using what |
| | Terms & Conditions. |
| Offering | Database of all Offering Rules established by the Producer |
| Rules | for use in an Offering at a future time. |
| Database | |
| Oversold | Inventory whose demand exceeds supply. |
| Inventory | |
| Perishable | Goods and Services whose value diminishes with time, |
| Goods and | eventually becoming worthless upon Expiration. |
| Services | Commercial act of transferring ownership or access to |
| Placement | goods & services from a Producer to a Purchaser. |
| Pricing | Formula developed by the Producer that contains specific |
| Algorithm | parameters and variables that will determine the behavior of |
| | a Pricing Mechanism during an Offering. |
| Pricing | Means by which the price associated with an Offering is |
| Mechanism | presented in real-time to the Purchaser through the Channel |
| | Interface, said means either determining the price or |
| | allowing the market or the Producer to determine the price, |
| | for example Dutch Auction, Bid-Ask, or Fixed Pricing. |
| Producer | Provider of Perishable Goods or Services |
| Purchaser | Channel end-user who conducts a Search Query against the |
| | Core Engine database via the Channel Interface. |
| Purchaser | Set of Purchaser-specific data, provided by the Channel or |
| Profile | by the Purchaser, which is used by the Core Engine to |
| | devise a Dynamic Offering based on rules set forth in the |
| | Purchaser Segment by the Producer. |
| Purchaser | Rules defined by the Producer that govern to whom the |
| Segment | Offering will be made or that modify the Offering based |
| Rules | on Purchaser - specific data contained in the Purchaser |
| | Profile. |
| Search | Values entered by the Purchaser through the Channel |
| Criteria | Interface to perform a Search Query. |
| Search | Information processing request containing Search Criteria |
| Query | that is conducted by a Purchaser through the Channel |
| | Interface, with the intent of filtering the database of |
| | available inventory and producing a result that meets |
| | requirements set forth in Search Criteria. |
| Sold | Inventory whose supply approximately equals demand. |
| Inventory | |
| Terms and | Non-price elements of an offering that specify rules |
| Conditions | of use and modification and grant the Purchaser certain |
| | rights and options. |
| Third Parties | Any party who wishes to offer Elements that are available |
| | at the time of construction of an Offering, except the |
| | Channel and the Producer. |
| Total Yield | Cash Yield plus the net present value of all potential |
| | future transactions with a specific Purchaser. |
| Unsold | Inventory that has not yet been placed. |
| Inventory | |
| Use of | Rights granted by the Producer to the Purchaser to access |
| Certain | certain assets held by the Producer, said rights |
| Assets | being granted in conjunction with acceptance by the |
| | Purchaser of the Offering. |
| Yield | The science of optimizing return from future inventory |
| Management | based on projections and modeling using historical data. |
| Yield | Any device that attempts to track the historical |
| Tracking | performance of inventory placement, such as an EXCEL |
| Tool | spreadsheet or a Yield Management System. |

### BRIEF DESCRIPTION OF THE DRAWINGS

FIG. 1 illustrates an overall view of the system of the present invention, key parties involved and relationships amongst the key parties.

FIG. 2 shows the end-to-end inventory placement process.

FIG. 3 is a diagram block that depicts the entry of inventory data process in detail.

FIG. 4 is a diagram block that depicts the entry of the offering rules process in detail.

FIG. 5 is a diagram block that depicts the creation of an intermediate offering using offering rules and inventory group codes.

FIG. 6 is a diagram block showing a synthesis of the method of the invention.

### DETAILED DESCRIPTION OF THE INVENTION

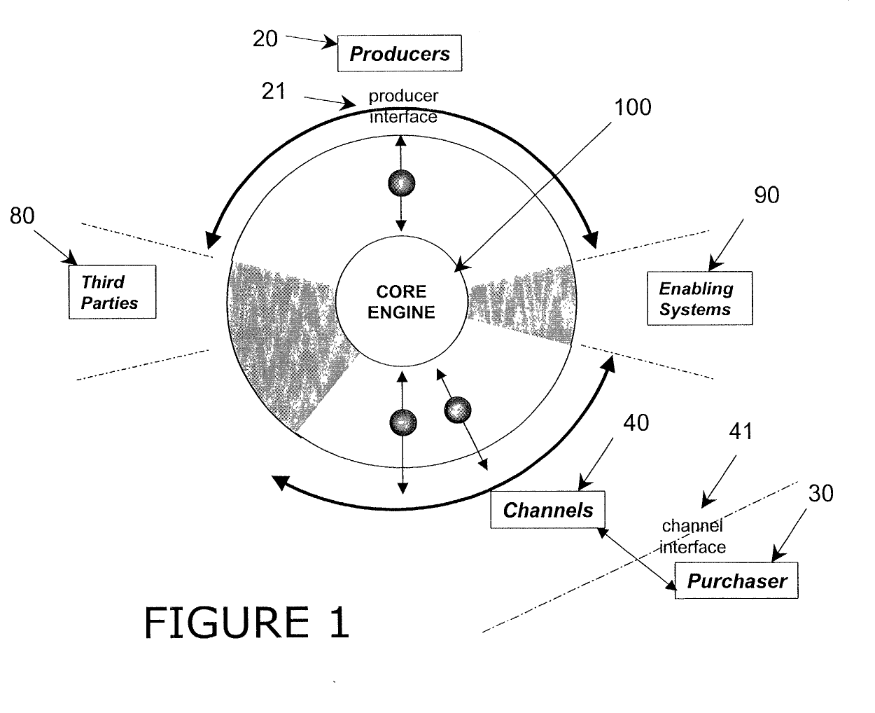

FIG. 1 shows the general structure of the system for the creation of a dynamic offering 10 for perishable goods and services in an electronic trading system according to the present invention, showing key parties involved and relationships amongst the key parties. Said system is accessible by at least, one producer 20 of perishable goods and services, one purchaser 30 and one channel 40. The system includes electronic/physical connections between all parties.

The system may also include access for third parties 80 with the corresponding interfaces; third parties may also include enabling systems 90 such as payment facilitators, reservations systems, logistics companies and credit card companies.

The method for the creation of a dynamic offering 10 works as follows:

Producers 20 load inventory into the Core Engine 100 via a producer interface 21, such as a web-based interface or en masse via electronic communication links that are specific to the type of producer hooked up to the system. The producer interface collects the following information from producers, partly through a web-based ASP interface, partly through direct connections with the producer's legacy sites:

a. Inventory codes that will be made available to channels 40, which will be tracked to the Inventory Details database 54 to provide full details on each unit of inventory (i.e.; flight departure and arrival times, city pairs, etc.)

b. Pricing and offering information, such as what the initial offering price will be, what the parameters governing the price movement and what the final price will be as well as when the offerings will take place. (i.e.; Dutch Auction starting at $700 and declining to $200 at the linear rate of $300 per hour, available Wednesday night at 8 pm GST).

c. Associated inventory and rules, such as what other value-added goods or services will be made available with this inventory (i.e.; all return flights from the destination on these dates with a Saturday night stay, maximum stay of thirty days, and minimum stay of two days).

d. Negotiation Rules, such as change privileges, display of producer information on the channel website, and various exchange and trading capabilities that will be granted to purchasers as part of the offering. (i.e.; offer free exchanges for a different flight on the same route).

e. Filtering rules that will dictate to whom will the inventory be made available, such as through which channels and to which target purchaser segments (i.e.; through all online travel agents and to all frequent flier members).

The Core Engine 100 contains databases and rules that will collect and store inventory information and dynamically formulate offers based on:

i. Supply conditions (i.e.; there are many seats to Frankfurt)

ii. The timing (i.e.; seats may be offered first on a travel web site and any remaining seats may be auctioned at the website of the producer)

iii. The nature of the channel (i.e.; Travelocity may get a different offering than eBookers)

iv. The buying history of the purchaser (i.e.; frequent flier)

v. Preferences of the purchaser (i.e.; prefers a limousine at the airport)

vi. Filtering of third party information for privacy protection purposes

vii. Aggregation and integration of third party offers into the offering (i.e.; electronic coupons, producer rebates to the channel or to the purchaser).

viii. Verification and validation of purchaser-specific profile and transaction data (i.e.; this purchaser is in fact a Gold member)

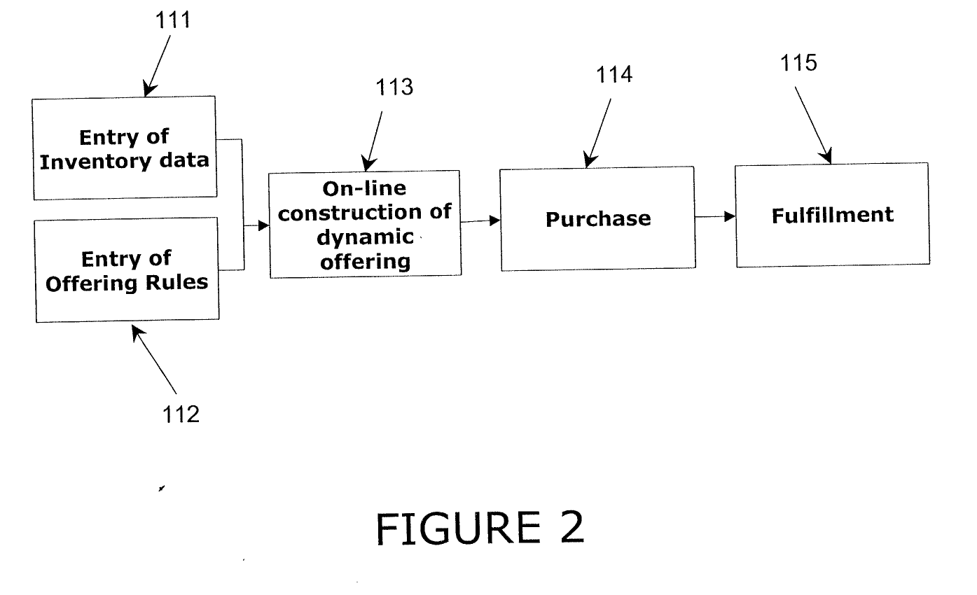

As shown in FIG. 2, once the Core Engine has constructed the dynamic offering, the other parties included in the system place the offering and provide fulfillment if the purchaser accepts said offering.

FIG. 2 shows the end-to-end inventory placement process:

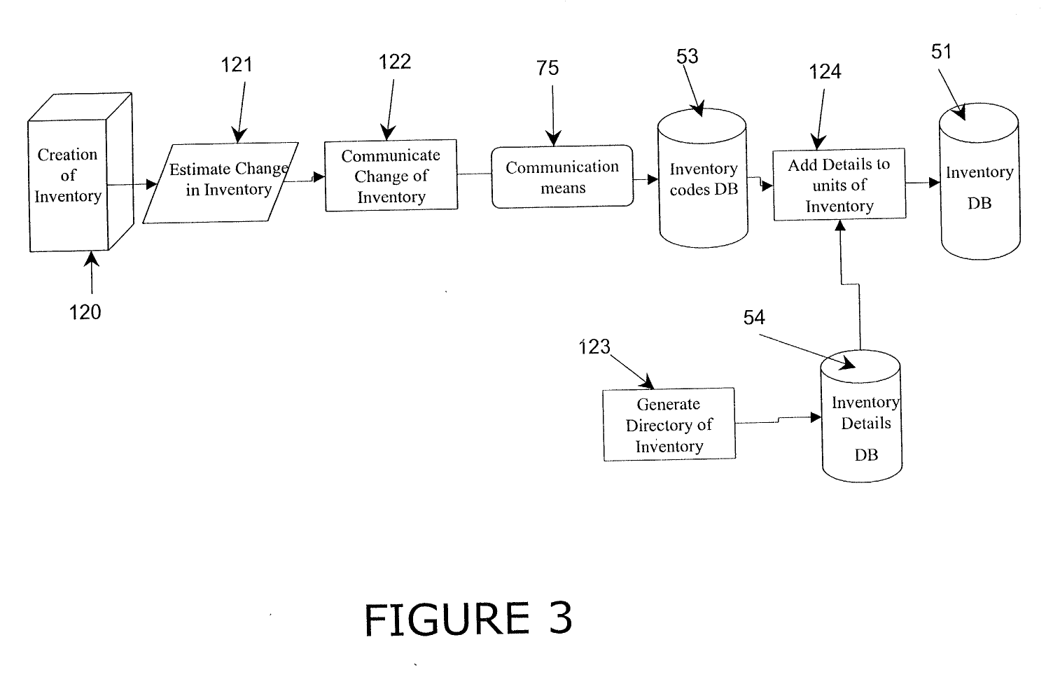

Box 111 involves the entry of inventory data (as further illustrated in FIG. 3), such as: flight numbers or similar product codes, dates, auction data, price data and association data, so that this unit may be linked with other units.

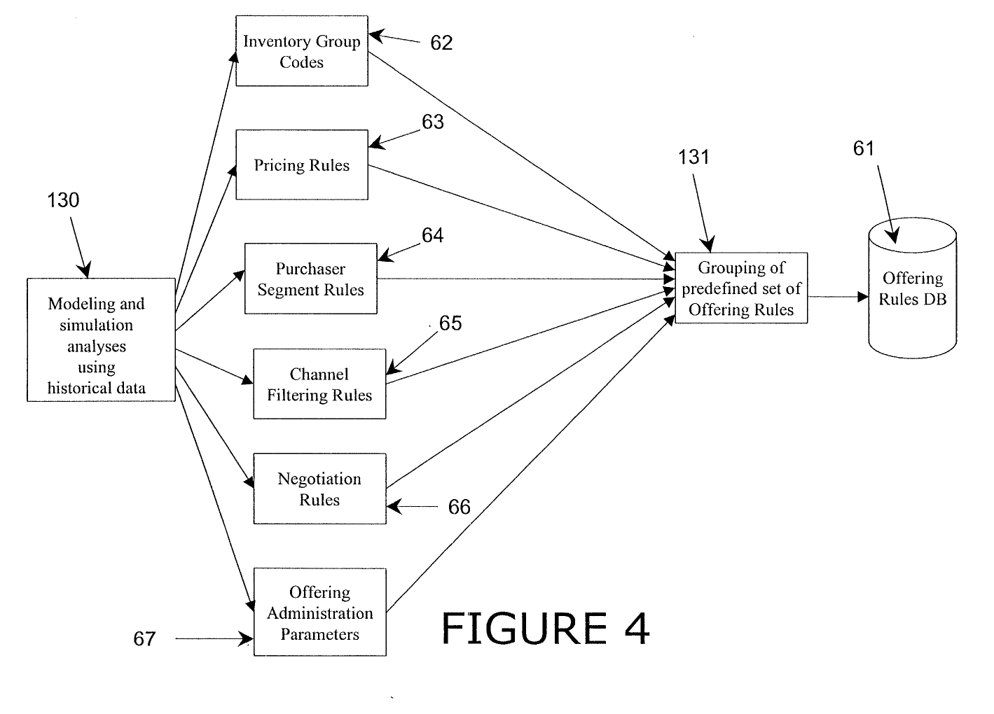

Box 112 involves the entry of offering data (as further illustrated in FIG. 4), such as: non-price elements that may be combined with the unit of inventory to create a dynamic offering, and offering and negotiation rules that will determine which purchasers get what combination of offering elements at what time through which channel, and filtering rules that will determine the channels to which the inventory will be offered.

Box 113 involves the on-line construction of an offering by the Core Engine using rules input by the producer and offering elements made available. Actual offering will depend on the following: buying history and preferences of the purchaser, supply conditions, non-price offering elements made available by the producer or the channel, the channel used by the purchaser, associations made by the producer to other units of inventory, the number of other purchasers of the inventory and the timing of those purchases, time and date and third-party offering elements that are available at the time of construction of the offering.

Box 114 involves the purchasing process, which is conducted by the channel and includes selection of the offering and transmission of payment information.

Box 115 involves the fulfillment of the offering, which is also conducted by the channel and includes reservation and delivery of the product being purchased.

FIG. 3 is a diagram that depicts the inventory data entry process in detail, which is basically as follows:

As shown in box 120, the producer manages the allocation and creation of inventory, using a yield tracking told such as historical yield data or a more sophisticated yield tracking tool such as a spreadsheet (such as Microsoft™ EXCEL), a relational database (such as Microsoft™ ACCESS), or a complex inventory management system such as a Yield Management System, the latter of which is based on complex statistical models; these models attempt to predict the amount of inventory needed based on historical sales.

Since the outcome of both informal formulations and statistical models is merely a prediction, there will be variances between predicted inventory needed and actual inventory required. As the expiration date of the unit of inventory approaches, the probability of placing all inventory becomes possible to estimate (box 121). Using this probability, the producer can identify “excess” inventory and “oversold” inventory (box 122). Units of inventory are identified using inventory codes (i.e.; flight numbers), which are organized and stored in the Inventory Codes Database 53.

The inventory codes are loaded into the Inventory Codes Database via communication means 75, for example a manual web interface or an electronic message. The manual web interface permits the producer to enter inventory manually via a password-protected website. In most cases, the inventory availability will be communicated en masse via electronic message; this method requires electronic links between the producer's inventory management systems and the Core Engine.

As shown in box 123, a directory of all inventory that could possibly be offered is generated. The producer enters inventory details into the Inventory Details database 54, which is a reference database; these details (e.g.; flight origination and destination, times, etc.) are generally fixed. In this way, the inventory codes are augmented (see box 124) with associated fixed data and are stored in the Inventory Database 51.

FIG. 4 is a diagram block that depicts the entry of the offering rules process in detail, which is basically as follows:

a) The producer may elect to analyze historical data concerning the relative effectiveness of various combinations of offering elements. In addition to historical analysis (box 130), the producer may elect to conduct simulations or models that attempt to predict the efficacy of a particular offering, based on information contained in the system already. Using these advanced analytical methods, the producer can predict to a certain extent the performance of a particular combination of offering elements for use in creating a new offer.

b) The producer enters or selects a predefined set of offering rules that will govern the elements and values that will be made available to a specific purchaser segment in a dynamic offering. Such rules formulate the offering based on:

i. The actual units of inventory requested

ii. The timing of the offering

iii. The buying patterns of the purchaser

iv. The preferences of the purchaser

V. Offering elements available at the time from third parties

vi. Pricing and auction parameters (pricing rules 63)

vii. Channel filtering rules 65

viii. Purchaser segment rules 64

ix. Association of inventory units

x. Negotiation rules 66

xi. Offering administration rules 67

The offering rules entered by the producer are grouped (box 131) and stored in the Offering Rules Database 61.

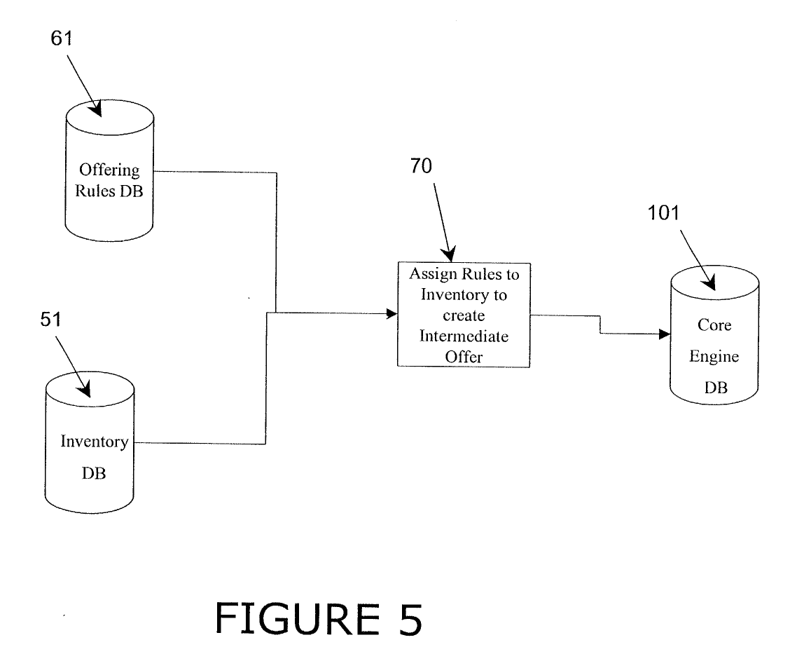

FIG. 5 is a diagram block that depicts the creation of an intermediate offer using offering rules and inventory group codes 62. The producer will use an offer management “control panel” to formulate various combinations of inventory group codes 62 and offering rules, which are selected from the Offering Rules database 61. Within these rules, the inventory group codes act as filters against the universe of all available inventory to select only the units of inventory that fit the criteria specified. This inventory is then combined with the offering rules to create a unique intermediate offer that is then loaded into the Core Engine database 101 for use at a future time.

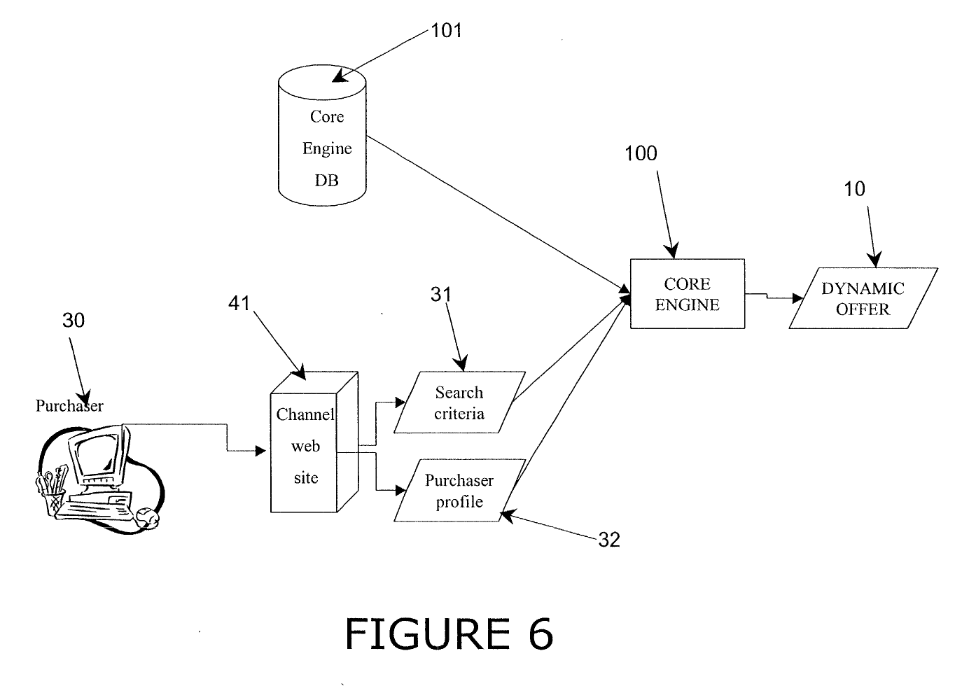

FIG. 6 is a diagram block showing a synthesis of the method of the invention. The purchaser 30 accesses the channel interface, i.e. a channel website 41, to which access has been provided. Through the system, search criteria 31 and purchaser profile 32 information are used to define the actual offerings that are made on behalf of the producer 20 to the purchaser 30. Based on the specific criteria in effect at the time, the Core Engine 100 constructs a dynamic offering 10 based on rules set in the Offering Rules database 61 and the details of individual units of inventory stored in the Inventory Database 51, which have been associated and stored in the Core Engine Database 101. Said dynamic offering is made available to the purchaser via said channel website 41. Should the purchaser accept the offer, the channel 40, third parties 80 and/or enabling systems 90 conduct the sale, including payment and fulfillment.

1. Method for the creation of a dynamic offering for perishable goods and services in an electronic trading system, being said system accessible by at least, one producer, one purchaser and one channel, said method comprising the steps of
the producer entering details about individual units of inventory, into an Inventory database via a producer interface
the purchaser interacting with the channel via a channel interface and entering details of purchaser profile and search criteria,
the producer electing to analyze historical data concerning the relative effectiveness of various combinations of offering elements, and conducting simulations that attempt to predict the efficacy of a particular offering, based on said historical data, and using said simulations, to predict the performance of a particular combination of offering elements to use in creating a new offering
the producer selecting and/or defining elements about offering rules, into an Offering Rules database via said producer interface,
the producer activating/deactivating said offering rules
the producer creating intermediate offers assigning the offering rules contained in the Offering Rules database to the inventory contained in the Inventory database, which intermediate offers are stored in a Core Engine database,
a core engine constructing a dynamic offering for said perishable good or service based on the intermediate offer contained in the Core Engine database and on the purchaser profile and search criteria,
such that the dynamic offering constructed is tailored uniquely to each purchaser, and optimizes both the producer and the purchaser situations, creating and adding value for both the producer and the purchaser and also to the channel.

2. Method according to claim 1, whereby the entry of inventory comprises the steps of
the producer generating inventory,
the producer identifying units of inventory to be made available and associating each unit to an inventory code, which inventory codes are organized and stored in an Inventory Codes Database,
generating a directory of all inventory that could possibly be offered,
the producer entering inventory details into an Inventory Details database,
the inventory codes are associated with said details and stored in the Inventory database.

3. Method according to claim 2, whereby said units of inventory include excess inventory, oversold inventory and standard inventory.

4. Method according to claim 1, whereby the entry of offering rules comprises the steps of
the producer entering a predefined set of inventory group codes, that act as filters against the Inventory database to select only the units of inventory that meet certain criteria,
the producer entering a predefined set of offering rules, which are organized and stored in the Offering Rules database, said offering rules including
i. pricing rules,
ii. purchaser segment rules,
iii. channel filtering rules,
iv. negotiation rules
v. offering administration rules
said offering rules being assigned to individual units of inventory based on predefined offering parameters.

5. Method according to claim 4, whereby said pricing rules determine both a pricing mechanism and a pricing algorithm to be used during the offering.

6. Method according to claim 4, whereby said purchaser segment rules designate characteristics of the purchaser segment to which the offering will be targeted.

7. Method according to claim 4, whereby said channel filtering rules determine through which channels the offering will be made available.

8. Method according to claim 4, whereby said negotiation rules designate certain non-price elements to be included in the offering, including Terms and Conditions and Use of Certain Assets.

9. Method according to claim 4, whereby said offering administration rules determine when an offering will be made available to the channels, for how long the offering will last and how often it will be repeated.

10. Method according to claim 1, whereby the method includes the steps of
notifying a third party via the corresponding interfaces of a potential transaction,
facilitating the participation of said third party in the offering and closing of the transaction.

11. Method according to claim 1, whereby producers and channels are provided with a means of presenting the offering in real time.

12. Method according to claim 4, whereby the producer has the ability to choose where the offering is presented, being able to decouple the choice of the pricing rules from the choice of the channel.

13. Method according to claim 12, whereby the producer has the ability to select specific purchaser segments, independently from the channel being used.

14. Method according to claim 4, whereby the producer has the ability to choose the negotiation rules, controlling the manner in which the offering is presented to the final purchaser.

15. Method according to claim 4, whereby the producer has the ability to offer non-price elements of value to the purchaser based on specific criteria, at a given point in time.

16. Method according to claims 11-15, whereby the producer combines the choice of the channel, the choice of the pricing rules and the choice of the negotiation rules into a single, effective decision making mechanism through which said producer has the ability to change each one of these components in real time, independently, and relative to any inventory grouping.

17. System for the creation of a dynamic offering for perishable goods and services in an electronic trading system, being said system accessible by at least, one producer, one purchaser and one channel, said system including electronic or physical connections between said parties, whereby said system includes,
a core engine, which constructs a dynamic offering for said perishable good or service based on an intermediate offer contained in a Core Engine database and on a purchaser profile and search criteria entered by said purchaser,
such that the dynamic offering constructed is tailored uniquely to each purchaser, and optimizes both the producer and the purchaser situations, creating and adding value for both the producer and the purchaser and also to the channel.

18. System according to claim 17, whereby the system includes an Inventory database which contains inventory data entered by the producer and an Offering Rules database, which contains offering rules entered by the producer.

19. System according to claim 18, whereby the offering rules include inventory group codes, pricing codes, purchaser segment rules, channel filtering rules, negotiation rules and offering administration rules.

20. System according to claim 17, whereby the system includes third parties with corresponding interfaces, who wish to offer elements that are available at the time of construction of the offer.

21. System according to claim 17, whereby the system includes third parties with corresponding interfaces, who wish to access the Core Engine directly through a specific Automatic Programmable Interface.

22. System according to claim 17, whereby the system includes Enabling Systems such as payment facilitators, reservations systems, logistics companies and credit card companies.
